(19) United States
(12) Patent Application Publication
(10) Pub. No.: US 2014/0029879 A1
(43) Pub. Date: Jan. 30, 2014

(54) COMBINATION OF A DRIVE SHAFT TRANSMITTING A TORQUE AND A BEARING ASSEMBLY MOUNTING THE DRIVE SHAFT

(71) Applicants: Horst Brehm, Bischberg (DE); Armin Gerner, Pommersfelden (DE); Eduard Beresch, Sulzheim (DE)

(72) Inventors: Horst Brehm, Bischberg (DE); Armin Gerner, Pommersfelden (DE); Eduard Beresch, Sulzheim (DE)

(73) Assignee: SCHAEFFLER TECHNOLOGIES AG & Co. KG, Herzogenaurach (DE)

(21) Appl. No.: 14/110,735

(22) PCT Filed: Mar. 26, 2012
(86) PCT No.: PCT/EP2012/055303

§ 371 Date: Oct. 9, 2013

(30) Foreign Application Priority Data
Apr. 15, 2011 (DE) 10 2011 007 465.1

(51) Int. Cl. G01L 3/10

(52) U.S. Cl. CPC G01L 3/101
USPC 384/446

(57) ABSTRACT

A combination of a drive shaft transmitting a torque and a bearing assembly mounting the drive shaft, characterized in that the bearing assembly (3) includes at least one integrated sensor device (4) for detecting a torsion-induced change of a magnetic field of a magnetized section (5) that is provided on the drive shaft (2) in the region of the bearing assembly (3) or is connected to the drive shaft (2) in a torque-resistant manner, the change of the field being a measure of the transmitted torque.

### FIELD OF THE INVENTION

The invention relates to a combination of a drive shaft transmitting a torque and a bearing arrangement supporting the drive shaft.

### BACKGROUND

The detection of torques of a rotating drive shaft by means of mechanically connected parts, e.g. a lever and a rod, is known. The detection of the torque by means of a hydraulic pressure is also used in practice.

The known combinations that are suitable for this of a drive shaft transmitting a torque and a bearing arrangement or devices supporting the drive shaft are, however, only partially suitable for detecting a torque, because the measurement causes wear via a lever and a rod during a torque measurement and the consequential maintenance costs and also maintenance times must be increasingly accommodated. Another disadvantage with known combinations that are suitable for this of a drive shaft transmitting a torque and a bearing arrangement or devices supporting the drive shaft is measurement of the torque by means of a hydraulic pressure, wherein the type of configuration results in complex control.

### SUMMARY

The invention has the objective of providing a combination, especially improved with respect to a torque measurement, of a drive shaft transmitting a torque and a bearing arrangement supporting the drive shaft for detecting the torque of a drive shaft.

In order to meet this objective for a combination of a drive shaft transmitting a torque and a bearing arrangement of the above-mentioned type supporting the drive shaft, according to the invention it is provided that the bearing arrangement comprises at least one integrated sensor device for the contactless detection of a torsion-related change of a magnetic field of a magnetized section provided on the drive shaft in the vicinity of the bearing arrangement or connected to the drive shaft in a torque-resistant manner, wherein the detected field change is a measure of the transmitted torque.

Thus with the combination according to the invention of a drive shaft transmitting a torque and a bearing arrangement supporting the drive shaft, advantageously a measurement by means of a lever and a rod, likewise the complex control of the hydraulic pressure, are not necessary, because the measurement takes place contactlessly. The bearing arrangement comprises at least one integrated sensor device for the detection of a torsion-related change of a magnetic field of a magnetized section provided on the drive shaft in the vicinity of the bearing arrangement or connected to the drive shaft in a torque-resistant manner. The change in the magnetic field of the shaft is simple to detect and directly proportional to the mechanical load. Thus the torque can be determined contactlessly and without wear. Also such sensor devices are insensitive to many application-typical influences, such as e.g. high temperatures, corrosive liquids, vibrations or mechanical shocks and most types of dust particles or dirt particles. However, with conventional sensor devices excessive temperatures can lead to demagnetization, likewise excessive vibrations, impacts and other mechanical shocks are normally disadvantageous. Furthermore, the sensor device enables torque detection without distortion of the detected torque, e.g. caused by a slope of a terrain or an inclination of the combination, because a slope force additionally acts on the combination as a result of the slope or the inclination, whereby this is loaded obliquely. However, this has no influence on the torque detection, because this takes place contactlessly and not by a measurement by means of a lever and a rod as in the prior art.

Any sensor device can be used as long as it enables a contactless torque measurement. The sensor device, especially the sensors, can be of active or passive form. Preferably, passive coils are to be used, because these are very robust and inexpensive to manufacture and can operate in applications with high operating temperatures. Passive sensors are sensors that only contain passive elements, e.g. coils, resistors or capacitors, and are operated without a permanently applied power supply. Active sensors, on the other hand, are measurement sensors that contain internal amplifying or signal-shaping components, e.g. transistors, thyristors, optical couplers or relays, and are operated with a power supply.

The sensor device can be disposed on a bearing supporting the working shaft, wherein of course the sensor device can be disposed on a different non-rotating component, as long as the magnetized section of the drive shaft remains detectable.

An outer ring of the bearing implemented as a radial bearing can be axially extended, wherein here the sensor device is disposed on the inside of the outer ring. Thus an additional unit can be avoided. Ideally, the sensor device is integrated in the bearing and can consequently be constructed as a unit, whereby there are no additional and high costs.

Advantageously, a circumferential groove is introduced on the inside of the outer ring, in which the annular sensor device can be disposed. Thus an additional radial installation space can be avoided.

An advantageous development of the invention provides for the sensor device to be mounted by means of a sealing element, especially a sealing ring, disposed on the bearing arrangement, especially on the outer ring, and sealed with respect to the drive shaft. This can be necessary in cases in which the combination is exposed to wet or humid climatic operating conditions. In this respect a failure of the electronics, especially the sensor device, can be avoided.

The width of the magnetized section can correspond essentially to the width of the sensor device. Of course, the width of the magnetized section or the width of the sensor device can vary, as long as there is sufficient coverage or detection of the change in the magnetic field is possible.

The magnetic section can be provided or formed on the drive shaft itself. Alternatively, the magnetized section can be provided or formed on the inner ring of the bearing that is connected to the drive shaft in a torque-resistant manner. A torque-resistant connection can e.g. be enabled by working processes such as gluing, welding, soldering or interference fit. Of course, other working processes can be used that enable a torque-resistant connection.

Furthermore, the invention relates to an agricultural working device, especially an agricultural vehicle, e.g. a self-propelled harvesting machine such as a combine harvester, a forage harvester, a sugar beet harvester or a potato harvester, comprising at least one combination of a working shaft and a bearing arrangement of the type described, wherein at least one operating parameter, which forms the basis of the subsequent operation of the working device, can be determined in a control device using the magnetic field change information determined by the sensor device. The working devices can e.g. be machines or vehicles comprising a power take-off shaft, a gearbox, a feeder, a drum, a shredder or a cutting unit. Using the determined magnetic field change information, operating parameters can be determined or adjusted. The invention can generally be used with towed machines such as balers (round and square balers), harvesting carriages, loading vehicles, hay tools, centrifugal mowers, cutting tools.

For example, using the determined torque on the drive shaft a conclusion about the transported quantity of transported material is possible. A response to the controller and/or to the driver can thus ensure an optimal speed of travel of a harvesting machine or a towed vehicle, which enables high utilization of working devices or agricultural vehicles without risking an overload with related damage, e.g. destruction of devices, units or bearings. In this respect a longer service life of the working devices is enabled.

Furthermore, the torque detection can also prevent blockages of the working devices by reducing the speed of travel. A so-called reversing operation, i.e. an operating mode which runs in reverse, can thus be avoided.

In addition, the control device, using the determined torque, can calculate the optimal application of a spreading material, e.g. from a fertilizer spreader, a manure spreader, a lime spreader, a salt spreader or a sand spreader (winter service), and can implement this with variations of the revolution rate of a centrifugal disk on the spreader.

### BRIEF DESCRIPTION OF THE DRAWINGS

Exemplary embodiments of the invention are illustrated in the figures and are described in detail below. In the figures:

FIG. 1 shows an illustration of the principle of a combination of a first embodiment according to the invention; and

FIG. 2 shows an illustration of the principle of a combination of a second embodiment according to the invention; and

FIG. 3 shows an illustration of the principle of an agricultural working device according to the invention, especially an agricultural vehicle of a first embodiment.

### DETAILED DESCRIPTION OF THE PREFERRED EMBODIMENTS

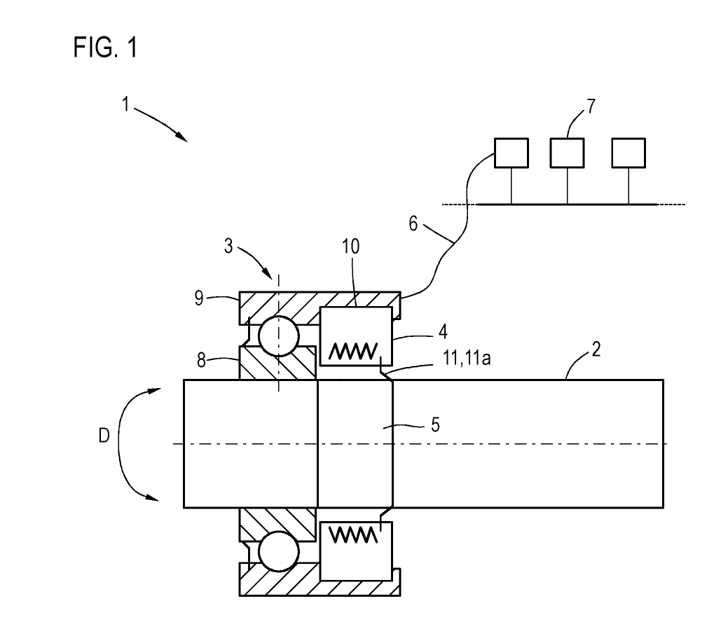

FIG. 1 shows, as an illustration of the principle, a combination 1 according to the invention, comprising a drive shaft 2 and a bearing arrangement 3 supporting the drive shaft 2, wherein the drive shaft 2 is rotatable about a horizontal axis. This is indicated by a rotation arrow D. Advantageously, a circumferential groove is introduced in the bearing arrangement 3 on the inside of the non-rotating outer ring 9, in which an annular sensor device 4 is disposed. This enables an additional radial installation space to be avoided.

The sensor device 4, here e.g. designed with coils, is used for the detection of a torsion-related change of a magnetic field of a magnetized section 5 provided on the drive shaft 2 in the vicinity of the bearing arrangement 3, said field change being a measure of the transmitted torque. In the magnetized section 5 of the ferromagnetic drive shaft 2 there are Weiss regions or domains, in which electron spins, which form the elementary magnets of the matter, are oriented in a parallel manner. If there is a torsion-related change of a magnetic field on the drive shaft 2, the Weiss regions or the domains in the magnetized section 5 change, whereby there is a change in the magnetic field. This change in the magnetic field of the shaft is easy to detect by means of the sensor device 4 and is directly proportional to the mechanical torsional load, enabling the torque to be determined with low wear and contactlessly. A local magnetization of the section 5 can e.g. be achieved with magnetization equipment with a permanent magnet.

The sensor device 4 is connected by means of a cable outlet 6 to a downstream control device 7, which processes the received signals e.g. in order to determine the optimal speed of travel and to reduce or increase the speed of travel or in order to determine the utilization/load of the machine. This information can be fed back e.g. using a visual display device, e.g. a display.

In the example shown a sealing element 11, preferably a sealing ring 11a, is disposed before the sensor device 4 in order to seal the sensor device 4 with respect to the drive shaft 2 and to prevent a failure of the electronics and thus a failure of the sensor device. The result of a failure of the sensor device would therefore be that the torque detection cannot be determined and thus e.g. an optimal spreading of the material to be spread cannot be determined.

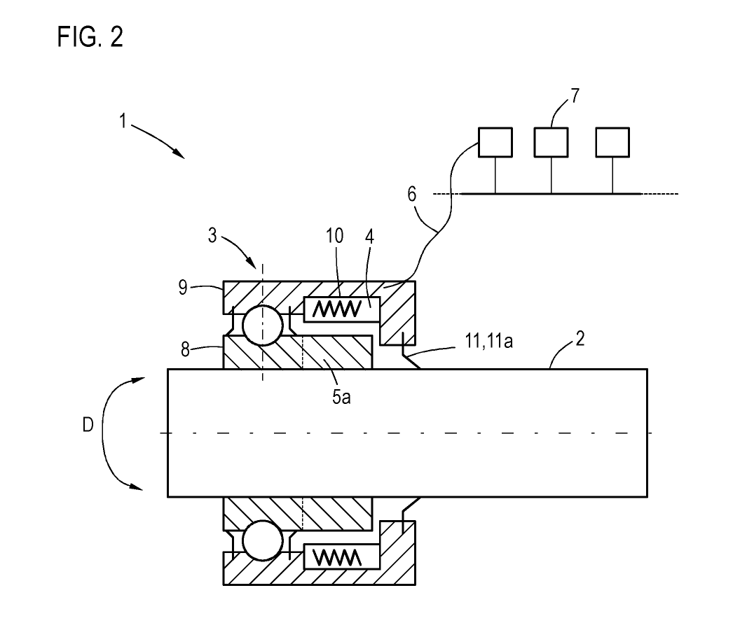

FIG. 2 shows a second embodiment of a combination 1 according to the invention, wherein as far as possible the same reference characters are used for the same components. FIG. 2 shows, as an illustration of the principle, a combination 1 according to the invention corresponding to FIG. 1, however the sensor device 4 detects the torsional change of a magnetic field of a magnetized section 5 on the inner ring of the bearing 8 that is connected to the drive shaft 2 in a torque-resistant manner, wherein the same principles apply as in FIG. 1. As a result the change in the magnetic field is also a measure of the transmitted torque here. A torque-resistant connection can be achieved e.g. by means of a working process such as gluing, welding, soldering or interference fit. The section 5 can be formed on the inner ring itself or attached to the inner ring as a separate annular component.

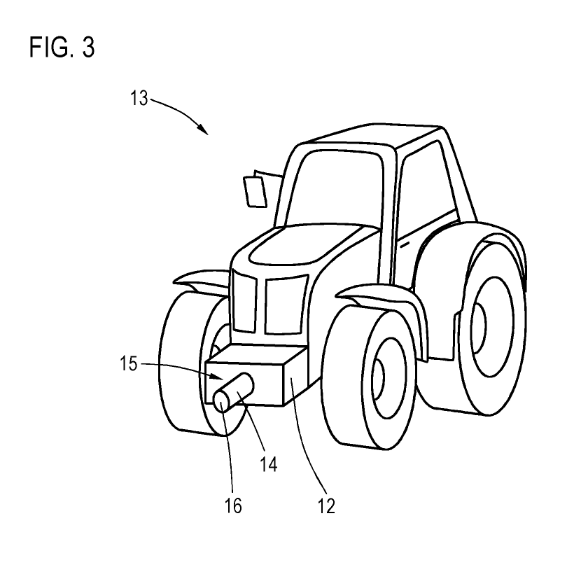

FIG. 3 shows, as an illustration of the principle, an agricultural working device according to the invention, especially an agricultural vehicle, in this case an exemplary tractor 13, wherein the tractor 13 comprises a working device 15 on the front side 14, e.g. an auxiliary output or a power take-off shaft 16, on which the combination 1 according to the invention, which is not shown in detail, is disposed in the housing 12. The detected torque signals are forwarded by the sensor device 4 to the control device 7, whereupon further steps are initiated. Also to be mentioned would be a calculation for the optimal spreading of a material to be spread, e.g. by a fertilizer spreader, a manure spreader or a lime spreader. The result leads e.g. to a variation of the revolution rate of a centrifugal disk on the spreader, so that optimal spreading of a material to be spread is ensured.

### LIST OF REFERENCE NUMBERS

1 combination

2 drive shaft

3 bearing arrangement

4 sensor device

5 magnetic section

5a magnetic part of the inner bearing ring

6 cable outlet

7 control device

8 inner bearing ring

9 outer bearing ring

10 groove

11 sealing element

11a sealing ring

12 housing

13 tractor

14 front side

15 working device

16 auxiliary output/power take-off shaft

1. A combination comprising a drive shaft transmitting a torque and a bearing arrangement supporting the drive shaft, the bearing arrangement comprises at least one integrated sensor device for detection of a torsion-related change of a magnetic field of a magnetized section provided on the drive shaft in a vicinity of the bearing arrangement or connected to the drive shaft in a torque-resistant manner, said field change being a measure of a transmitted torque.

2. The combination as claimed in claim 1, wherein the sensor device is located on a bearing supporting the working shaft.

3. The combination as claimed in claim 2, wherein the bearing is a radial bearing and includes an outer ring that is axially extended, and the sensor device is located on an inside of the outer ring.

4. The combination as claimed in claim 3, wherein the sensor device is annular, the outer ring includes a circumferential groove, and the annular sensor device is located in the circumferential groove.

5. The combination as claimed in claim 1, wherein the sensor device is enclosed by a sealing element, located on the bearing arrangement, and sealed with respect to the drive shaft.

6. The combination as claimed in claim 1, wherein—viewed axially—a width of the magnetized section essentially corresponds to a width of the sensor device.

7. The combination as claimed in claim 1, wherein the magnetized section is provided or formed on the drive shaft itself, or the magnetized section is provided or formed on an inner ring of the bearing arrangement that is connected to the drive shaft in a torque-resistant manner.

8. An agricultural working device, comprising at least one combination of a working shaft and a bearing arrangement as claimed in claim 1 wherein at least one operating parameter, which forms a basis of a subsequent operation of the working device, is determined in a control device using the magnetic field change information determined by the sensor device.

9. The combination as claimed in claim 5, wherein the sealing element is a sealing ring that is located on the outer ring of the bearing arrangement.
